(19) United States
(12) Patent Application Publication
(10) Pub. No.: US 2013/0090931 A1
(43) Pub. Date: Apr. 11, 2013

(54) MULTIMODAL COMMUNICATION SYSTEM

(71) Applicants: Maysam Ghovanloo, Atlanta, GA (US); Xueliang Huo, Atlanta, GA (US)

(72) Inventors: Maysam Ghovanloo, Atlanta, GA (US); Xueliang Huo, Atlanta, GA (US)

(73) Assignee: Georgia Tech Research Corporation, Atlanta, GA (US)

(21) Appl. No.: 13/542,399

(22) Filed: Jul. 5, 2012

Related U.S. Application Data
(60) Provisional application No. 61/504,508, filed on Jul. 5, 2011.

(51) Int. Cl. G06F 3/01; G10L 15/26

(52) U.S. Cl. CPC G06F 3/011; G10L 15/265; G06F 3/012
USPC 704/275; 345/156

(57) ABSTRACT

The present invention, in various embodiments, comprises systems and methods for providing a communication system. In one embodiment, the system is an assistive technology (AT) in a single, highly integrated, multimodal, multifunctional, multipurpose, minimally invasive, unobtrusive, wireless, wearable, easy to use, low cost, and reliable AT that can potentially provide people with severe disabilities with flexible and effective computer access and environmental control in various conditions. In one embodiment, a multimodal Tongue Drive System (mTDS) is disclosed that uses tongue motion as its primary input modality. Secondary input modalities including speech, head motion, and diaphragm control are added to the tongue motion as additional input channels to enhance the system speed, accuracy, robustness, and flexibility, which are expected to address many of the aforementioned issues with traditional ATs that have limited number of input channels/modalities and can only be used in certain conditions by a certain group of users.

### CROSS REFERENCE TO RELATED APPLICATION

This application claims the benefit under 35 U.S.C. §119(e) of U.S. Provisional Patent Application No. 61/504,508, filed 5 Jul. 2011, entitled “Multi-Modal, Multi-Functional, and Multi-Purpose Wireless Assistive Technology for People with Different Levels of Disabilities,” which is incorporated herein by reference as if set forth below.

### TECHNICAL FIELD

The present system relates generally to communication systems, and more specifically, communication systems using multiple modalities of input and output.

### BACKGROUND

After decades of development, it has been found that in order to create an effective communication system of communication, two communication inputs are typically required. For example, computer users typically need at least one discrete input and one proportional input. The discrete input usually takes the form of a keyboard, by which the physical depression of a key out of a group of keys, each of which is associated to a particular character or function, creates a discrete output corresponding to that particular character or function that is linked to the key that is depressed. The proportional controller often takes the form of a mouse or touchpad. The non-linear, non-discrete input in 1-, 2-, or 3-D (e.g. a continuous rotation of knob, linear movement of a slider, 2-D movement of a mouse on a mouse pad or a finger on a touchpad, or a 3-D gyroscope) creates a continuous and proportional 1-D, 2-D, or 3-D output, which can then be linked to the position of a cursor in a 1-D, 2-D, or 3-D space (e.g. mouse cursor on the computer screen) or a parameter such as sound volume.

Both the proportional and discrete outputs are used in conjunction with each other to provide the user with a means for effective and efficient communication with the system. When a discrete input is needed, the keyboard works more efficiently than the mouse pad. For example, a typical person will be able to create sentences by typing faster via the use of a keyboard than a proportional controller, e.g. using an on-screen keyboard with a mouse. Although a proportional controller can be more efficient in a limited number of circumstances, overall the keyboard is a faster means of creating textual input. One instance in which a proportional controller may be used in lieu of a keyboard is a computer tablet-stylus pen combination, but the use is usually one of convenience, portability, etc, rather than efficiency or speed. When using a stylus pen to create text, the computer must perform optical character recognition on the text if the text is to be used in a manner other than just an image. So, even in these circumstances, the keyboard would still be a higher performing substitute but for the fact that the presence and use of the keyboard itself is inconvenient.

Thus, a multimodal system, one that provides for more than one way in which to create an input into a system can increase the efficiency of a user when communicating through a system. Conventional means of providing multimodal systems for people of varying levels of disabilities has been ineffective in a lot of circumstances, if it has been contemplated at all.

Assistive technologies (“AT”s) enable individuals with severe disabilities to communicate their intentions to other devices, particularly computers, as a mean to control their environments. This will ease the individuals' need for receiving continuous help, thus reducing the burden on their family members, releasing their dedicated caregivers, and reducing their healthcare and assisted-living costs. It may also help them to be employed and experience active, independent, and productive lives.

It is generally accepted that an individual with disability plus the right assistive technology can function as a person without limitation. In addition, computing and internet technologies are great equalizers enabling all individuals to have similar vocational and recreational opportunities. Once an individual with disability is “enabled” to effectively access a computer, he/she can virtually do everything that an able-bodied individual can do with that computer. This includes controlling other devices such as powered wheelchairs (PWC), assistive robotic manipulators, and other home/office appliances that are connected directly to that computer or through a local area network (LAN). Even the individual's own natural or prosthetic limbs can be manipulated to make a move by employing functional electrical stimulation (FES).

Despite the fact that a wide variety of assistive devices are available for people with lower levels of disabilities, those with severe disabilities such as high level spinal cord injury (SCI) patients, who need ATs the most, have very limited options. Even the existing ATs have numerous shortcomings and impose major limitations on the users' capabilities and diminish their quality of life.

Sip-n-puff (also known as blow-and-suck) is a simple, low-cost, and easy to use AT, which allows users to control their PWC by blowing or sucking through a straw. However, it's limited number of direct choices (only 4), slow command input, and awkward appearance (resembling an elephant trunk), are unattractive to the majority of users. It also needs frequent cleaning and cannot be used by those who do not have enough diaphragm pressure.

A group of ATs known as head pointers or head arrays require a certain level of head movement ability that a disabled person may not be able to provide. They are also susceptible to inertial forces applied to the head when PWC is in motion, particularly in users that have weaker neck muscles. Another group of ATs, based on eye movement tracking have been successful for computer access. However, they are not safe for controlling PWCs because they may interfere with the users' normal visual tasks. They are also known to cause headache in some users after long term usage (a few hours) because of the interference between visual and manipulating functions of the eyes when using this technology.

There are ATs that utilize bioelectric signals such as electromyogram (EMG) from facial muscles or electro-oculogram (EOG) around the eyes. However, attaching surface electrodes to the face is neither comfortable nor cosmetically desirable. Noninvasive brain computer interfaces (BCIs) use either electroencephalography (EEG) from the scalp or near infrared (NIR) signals. These devices are very slow due to limited signal bandwidth, need a high level of concentration, and offer limited degrees of freedom (DoF). Because these signal sources are very weak, they are also highly susceptible to external interfering signals such as the 60 Hz power line or ambient light.

A few invasive BCIs, using intracortical neural signals or subdural electro-corticograms (ECoG), are also under development, which are expected to be faster than EEG-based BCIs with more DoF. However, these BCIs are costly and highly invasive (they need the user to undergo a brain surgery). Therefore, they may not be desired by the majority of end users, particularly when less invasive alternatives are available. There are also environmental controllers that use voice commands, alone, as input. These systems can be suitable for computer access in quiet environments. However, they are not reliable for PWC control in noisy and outdoors environments. They also need diaphragm control, as well as functional vocal cords, which may not be available as a body function to some end users.

Tongue capabilities have resulted in development of a few tongue-operated ATs, such as the Tongue-Touch-Keypad. These devices require bulky objects inside the mouth, which may interfere with speech, ingestion, and sometimes breathing. There are also a number of mouth-operated joysticks, which can provide proportional control. However, they can only be used in a certain position and require head movement to grab the mouthpiece. They also require tongue and lip contact and pressure, which may cause fatigue and irritation over long-term use.

One of the major limitations of current ATs is that each single AT is designed for a limited set of specific tasks due to the different nature of the tasks and their requirements. Therefore one AT, which works perfectly well for one set of tasks by one user, might show poor performance in other tasks by the same user or even completely lose its functionality when used for other applications by other users. For example, sip-n-puff has been widely accepted and used to drive a PWC by a large population of severely disabled users because it is simple, low cost, and easy to use and maintain. However, this system is not favored by the same users for computer access due to the limited number of direct choices (4 commands), being slow, and requiring continuous diaphragm function, which can potentially be exhausting in long-term continuous computer usage.

Therefore, those users often rely on other ATs such as head trackers or voice controllers for computer access. Another example is the eye tracking systems. The eye tracking systems have been proved to be effective and efficient in controlling mouse cursor to complete pointing tasks for computer access. However, it is not quite practical and safe to use eye tracking systems alone to control powered wheelchairs since these systems affect the users' normal vision by requiring extra eye movements (in many cases, it is not clear whether the user is issuing a command or simply gazing on an object, a.k.a. the Midas touch problem), they are significantly affected by changes in the ambient light (for example they might render useless in direct sunlight), and they often need a camera or infrared source and sensor pair to be positioned in front of the eyes or face, mounting and positioning of which on a mobile platform such as a wheelchair may not be quite feasible.

In addition, the performance of the traditional AT that are often single-modality can be further affected by the operating conditions, such as the environment, and users' condition, such as fatigue, spasms, sickness, thick accent, etc. For instance, the speech recognition has been considered as one of the most effective methods for text entry in quiet settings. However, the ambient acoustic noise can significantly degrade the quality of sound acquired by the microphone and affect the accuracy of the speech recognition software. As a result, the system might show poor performance in translating users' verbal commands or becomes even completely irresponsive in the noisy and outdoors environments, and render the AT useless. Another type of devices that shows strong environmental dependent performance is eye tracking systems. The camera based eye tracking systems are very sensitive to the environment lighting conditions and need to be recalibrated when the lighting conditions change. This requires additional intervention from the caregiver and reduces the level of independency of the user.

Among ATs those providing alternative control for computer access and wheeled mobility are considered the most important for today's lifestyle since they can potentially improve users' quality of life by easing two major limitations: effective communication and independent mobility. Unfortunately, none of the existing ATs can effectively and safely address both applications alone. Individuals with severe disabilities, who desire a real independent and self-sufficient life, usually have to learn and use multiple ATs in order to access different devices in different environments (home, office, outdoors, etc.), and try to expect and cope with different conditions that they may face in their daily lives.

For example, it is a quite common that individuals with high level SCI use sip-n-puff to drive their wheelchairs, head pointer to control the mouse cursor, speech recognition software to type, and a mouth stick to control their phones and home appliances. In many similar cases, unless the individuals are highly motivated, it is very likely that they might be burdened with learning how to use multiple ATs for various tasks or conditions, the cost and maintenance of multiple ATs might be prohibitive to them, and switching from one AT to another often needs assistance from a caregiver, who may or may not be available at all times and all locations. The result is that many individuals may prefer to stay only in one environment, home for example, and not to participate in many activities that might be beneficial to their mental and physical health as well as to the society, and consequently degrade their quality of life. A highly integrated multimodal and multifunctional AT can have life changing consequences in such circumstances.

Yet another major concern that many individuals who use multiple ATs to remain active in their local environments and communities have is travelling. The abovementioned configurations are quite inconvenient and sometimes impractical for travelling when users have to carry around all the ATs that they need to be able to function when they are away from their local customized environments. Because most often each AT needs to be set up and recalibrated in the new environments. Moreover, being surrounded by a number of ATs that are not necessarily conventional or used by others, raises cosmetic issues and attracts undesired attention, which in general is a great concern to many users when they are in public. As a result, individuals with high level disabilities may forgo opportunities that would affect their personal, occupational, and societal standing, and of course their quality of life.

### BRIEF SUMMARY OF THE DISCLOSURE

Briefly described, the present invention, in various embodiments, comprises systems and methods for providing a communication system. In one embodiment, the system is an assistive technology in a single, highly integrated, multimodal, multifunctional, multipurpose, minimally invasive, unobtrusive, wearable, easy to use, low cost, and reliable AT that can potentially provide people with severe disabilities with flexible and effective computer access and environmental control in various conditions. In one embodiment, a multimodal Tongue Drive System (mTDS) is disclosed that uses tongue motion as its primary input modality. The exemplary mTDS can wirelessly detect a tongue position inside the oral cavity of the user and translate its motion into a set of user-defined commands. These commands can then be used to access a computer, operate a PWC, or control devices in the user's environment. Secondary input modalities including speech, head motion, and diaphragm control are added to the tongue motion as additional input channels to enhance the system speed, accuracy, and flexibility, which are expected to address many of the aforementioned issues with traditional ATs that have limited number of input channels/modalities and can only be used in certain conditions.

One embodiment of the present invention is a multi-modal communication system for use by a subject, the system comprising a primary modality comprising a tongue tracking unit comprising a tracer unit for use on a tongue of the subject, a sensing unit comprising a primary sensor configured for placement in proximity to tongue carrying the tracer unit, wherein the primary sensor detects a position of the tracer unit to output a first type of communication, and a plurality of secondary modalities comprising one or more secondary sensors to output a second type of communication.

In some embodiments, the first type of communication is proportional and the one or second types of communications are discrete.

In some further embodiments, the first type of communication is discrete and the second type of communication is proportional.

In further embodiments, the tracer unit comprises a magnet. The magnet can be coated with a material selected from the group consisting of gold, platinum, titanium, and polymeric material. The magnet can be affixed to the tongue by piercing the tongue with a piercing embedded with the magnet or is glued to the tongue.

In still further embodiments, the sensing unit is selected from the group consisting of a headset and a mouthpiece.

In some embodiments, the one or more secondary sensors comprise a head motion sensor. The head motion sensor comprises an inertial measurement unit. The inertial measurement unit comprises a 3-axial magnetometer, a 3-axial accelerometer and a 3-axial gyroscope.

In further embodiments, the one or more secondary sensors comprise a speech or acoustic sensor. The speech or acoustic sensor comprises a microphone. The speech or acoustic sensor can further comprise an earphone.

In additional embodiments, the one or more secondary sensors comprise a respiratory or pneumatic pressure sensor. The respiratory or pneumatic pressure sensor comprises a tube configured to transmit breathing or diaphragm pressure generated by the subject.

In further embodiments, the sensing unit further comprises a wireless transceiver unit for wirelessly transmitting and receiving data.

In some embodiments, the first type of communication is combined with one or more of a second type of communication, a third type of communication and a fourth type of communication to output a fifth type of communication.

In still further embodiments, the first type of communication can be sent as an input to a plurality of secondary modalities.

The foregoing summarizes only a few aspects of the presently disclosed subject matter and is not intended to be reflective of the full scope of the presently disclosed subject matter as claimed. Additional features and advantages of the presently disclosed subject matter are set forth in the following description, may be apparent from the description, or may be learned by practicing the presently disclosed subject matter. Moreover, both the foregoing summary and following detailed description are exemplary and explanatory and are intended to provide further explanation of the presently disclosed subject matter as claimed.

### BRIEF DESCRIPTION OF THE DRAWINGS

The accompanying drawings, which are incorporated in and constitute a part of this specification, illustrate multiple embodiments of the presently disclosed subject matter and, together with the description, serve to explain the principles of the presently disclosed subject matter; and, furthermore, are not intended in any manner to limit the scope of the presently disclosed subject matter. Any headings provided herein are for convenience only and do not necessarily affect the scope or meaning of the claimed presently disclosed subject matter. Wherever possible, the same reference numbers are used throughout the drawings to refer to the same or like elements of an embodiment, and wherein:

FIG. 1 is an illustration of an exemplary system according to various embodiments of the present invention.

FIGS. 2a-c are illustrations showing various ways in which a magnet may be affixed to the tongue of a user, according to various embodiments of the present invention.

FIG. 3 illustrates an exemplary control unit, according to various embodiments of the present invention.

FIG. 4 shows the flowchart of the headset MCU firmware, which is related to the wireless handshaking function, according to various embodiments of the present invention.

FIG. 5 is a block diagram of an exemplary USB transceiver, according to various embodiments of the present invention.

FIG. 6 shows the firmware flowchart of this wireless handshaking procedure implemented in the MCU of the transceiver dongle, according to various embodiments of the present invention.

FIG. 7 shows the firmware flowchart of the USB transceiver that implements the wireless file transfer function, according to various embodiments of the present invention.

FIG. 8 is a block diagram of an exemplary PWC-smart phone transceiver, according to various embodiments of the present invention.

FIG. 9 is a flowchart of PWC control function implemented on the PWC-smart phone transceiver, according to various embodiments of the present invention.

FIG. 10 shows the flowchart of PWC-iPhone transceiver operation in the file transfer mode, according to various embodiments of the present invention.

FIG. 11 depicts the results from human subject trials, divided into the typing time, cursor navigation time, and total time for completing the task using three different solutions.

### DETAILED DESCRIPTION

The subject matter of the various embodiments is described with specificity to meet statutory requirements. However, the description itself is not intended to limit the scope of this patent. Rather, it has been contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly required. It should be understood that the explanations illustrating data or signal flows are only exemplary. The following description is illustrative and non-limiting to any one aspect.

It should also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named. Also, in describing preferred embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” one particular value and/or to “about” or “approximately” another particular value. When such a range is expressed, other exemplary embodiments include from the one particular value and/or to the other particular value. The terms “comprising” or “containing” or “including” mean that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified. To facilitate an understanding of the principles and features of the presently disclosed subject matter, embodiments are explained hereinafter with reference to implementation in an illustrative embodiment.

In some embodiments, the present invention is a multimodal Tongue Drive System (mTDS) that is a single, highly integrated, multimodal, multifunctional, multipurpose, minimally invasive, unobtrusive, wireless, wearable, easy to use, low cost, and reliable AT that can potentially provide people with severe disabilities with flexible and effective computer access and environmental control in various conditions. In one embodiment, a multimodal Tongue Drive System (mTDS) of the present invention uses tongue motion as its primary input modality, or a first type of communication output. The mTDS of one embodiment of the present invention can wirelessly detect the tongue position inside the oral cavity and translate its motion into a set of user-defined commands. These commands can then be used to access a computer, operate a powered wheelchair (PWC), or control devices in the user's environment.

Secondary input modalities, providing second types of communication, including speech, head motion, and diaphragm control can be added to the tongue motion as additional input channels to enhance the system speed, accuracy, and flexibility, which are expected to address many of the aforementioned issues with traditional ATs that have limited number of input channels/modalities and can only be used in certain conditions. Depending on the number of secondary input modalities, the secondary input modalities can provide third, fourth, etc. types of communication outputs.

In some embodiments, an mTDS of the present invention can be a highly integrated assistive technology that can provide an end user with multiple control functions for different purposes in various environments. Some embodiments of the system operate based on the information acquired from multiple input channels, including those related to tongue motion, speech, head motion, and diaphragm-controlled air pressure, or various combinations thereof, each of which is processed independently but fused together at the end to generate a set of user-defined commands for specific tasks, user conditions, and environments. In some embodiments, the first type of communication, e.g. the tongue location, can be an input to one or more second types of communication systems.

A primary modality of the mTDS is based on detecting and tracking the free voluntary tongue motion in the 3D oral cavity using, in some embodiments, a magnetic tracer attached to the tongue via piercing, implantation, adhesives, or clipping and an array of magnetic sensors, or tongue drive system (TDS). In some embodiments, the TDS is a small permanent magnetic tracer is attached to the tongue using tissue adhesives, clipping, piercing, or tongue implantation. The magnetic field generated by the tracer varies inside and around the mouth with the tongue movements. These variations are detected by the array of magnetic sensors that are positioned inside (iTDS) or outside (eTDS) the mouth and wirelessly transmitted to a smartphone, such as an iPhone or an ultra mobile personal computer (UMPC), which can be worn by the users or attached to their PWC. A sensor signal processing (SSP) algorithm running on the UMPC classifies the sensor signals and converts them into user-defined control commands, which are then wirelessly communicated to the target devices in the users' environment. It should be understood that magnetic-based location systems are merely exemplary, as other types of tongue location systems may be implemented, including, but not limited to, infrared-based systems, all of which are considered to be within the scope of the present invention.

The secondary input modalities that can be selected and customized based on individuals' existing abilities include but not limited to the vocal commands generated from users' continuous and discrete speech, the acceleration and rotation resulted from the voluntary head movements, and the diaphragm or oral controlled air pressure applied by the user by sipping and puffing through a straw. In a preferred embodiment of the present invention, the tongue-based primary modality from the TDS components is always active during the operation of the mTDS and regarded as the default input modality for both computer access and PWC control. The tongue commands resulted from the TDS modality is also used to interact with the graphical user interface (GUI) to enable and disable secondary modalities without caregivers' assistance as users engage in different tasks. All secondary modalities of the mTDS can be selectively turned on or off using tongue motions depending on whether they are needed or not to reduce the power consumption of the system and extend the battery lifetime.

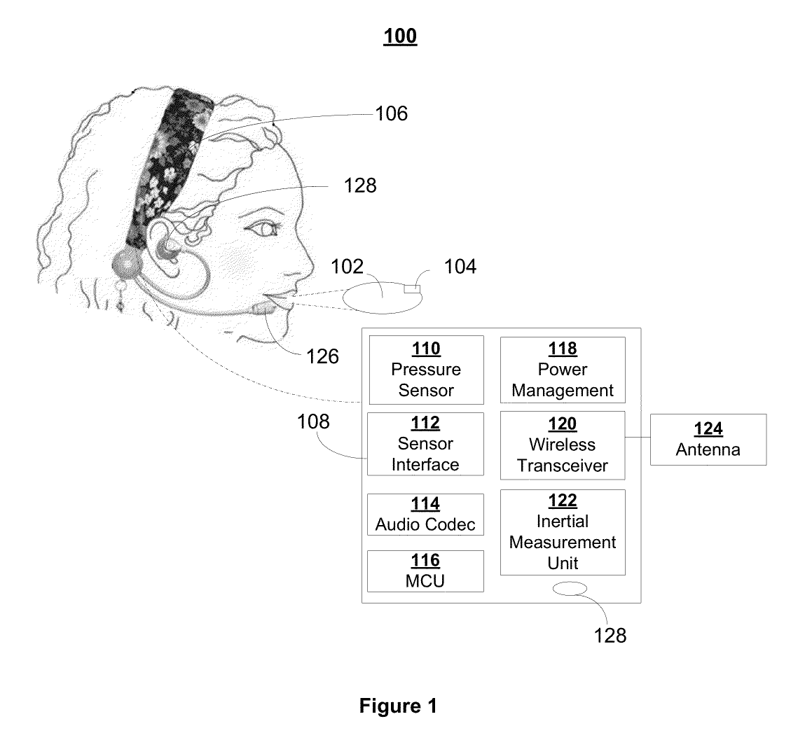

An exemplary mTDS 100 according to various embodiments of the present invention are illustrated in FIG. 1. A small permanent magnetic tracer 102 attached to a tongue of a user 100. The magnetic tracer 102 is comprised of a small permanent magnet coated with biocompatible non-ferromagnetic material (such as gold, platinum, titanium, or polymers) that can be temporarily secured on the tongue 102 using tissue adhesives or can be secured on the tongue 102 in a more permanent manner. For example, for long term usage, the user can receive a tongue piercing embedded with the magnetic tracer. Tongue piercing is a minimally invasive procedure, which is completely reversible as the resulting hole in the tongue quickly closes and disappears after the tongue stud is removed. Alternatively, the magnet in the magnetic tracer 104 can be implanted under the tongue mucosa to make the magnetic tracer 104 completely invisible.

However, using the magnetic tongue stud and piercing is advantageous to tongue implantation. Because in the former case, the tongue stud can be temporarily removed and substituted with a soft plastic tubing for procedures such as magnetic resonance imaging (MRI) and reinserted after the procedure. Removing the tongue implantation may, however, be more involved and require a small surgery.

The magnetic field generated by the magnetic tracer varies due to tongue movements. Since human tissue is transparent to the DC and low frequency magnetic field, this variation of the magnetic field can be measured using sensors located outside of the mouth also.

To detect the location of the magnetic tracer, a wireless headset 106 can be provided. Wireless headset 106 can comprise a group of sensors and transducers to detect the tongue 102 motion as primary input and the speech, head motion and respiratory pressure as secondary input modalities. Wireless control unit 108 can packetize and wirelessly transmit the magnetic, acoustic, acceleration, and pressure data. Various types of data may be received and transmitted by control unit 108. For example, pressure data from a pressure sensor 110 can be received at sensor interface 112, processed by the MCU 116 and transmitted to an outside device using wireless transceiver 120 and antenna 124. Voice can be received at audio codec 114, processed by MCU 116 and output to an outside device in similar manner. If head movement is one of the secondary modalities, inertial measurement unit 122 can receive the head movement data and output that data. Power management component 118 can help maintain power output and conserve the power of battery 128.

Variations in the magnetic field intensity (B) due to the magnetic tracer 104 movements can be detected by an array of magnetic sensors 126, which is mounted on the wireless headset 106 and extended towards users' cheeks. These magnetic sensors, which can be magneto-inductive sensors, Hall Effect sensors, fluxgates, magneto-resistive sensors, or magneto-impedance sensors, remain stationary on the headset 106 with respect to the mouth and relative to each other. In a preferred embodiment of the present invention, only one sensor is activated at a time to measure the magnetic field to save power.

At least one miniaturized microphone, shown in FIG. 1 as integrated with magnetic sensors 126, can be incorporated in the headset 106 along with the magnetic sensor 126, and located close to the users' mouth to capture the user's voice. In one embodiment, the audio codec 114 has sound playback capability and is included in the headset 106 to provide the user with the audio feedback when desired by attaching an earphone 128 to the headset 106. With the combination of the microphone in sensor 126 and the audio playback function, the headset 106 can also be used as a wireless headphone to substitute standard wireless headsets, such as Bluetooth headsets. It can, therefore, allow users to talk on the phone and also dial numbers all through the mTDS.

In order to track the users' head motion, an inertial measurement unit (IMU) 122, including a 3-axial magnetometer, a 3-axial accelerometer and a 3-axial gyroscope, has been added to the headset 106 to measure the tilting and rotation of the headset 106, which represent the users' head movements with respect to gravity and earth magnetic field.

Some embodiments of the present invention also include a compact pressure sensor 110, which input is connected to a plastic tubing or straw (not shown) that extends to the proximity of the users' mouth in a way that they can grab the tip of the straw with their lips and blow air into it or suck air from it to issue commands. In this way, the mTDS can be used as a sip-n-puff device to convert pneumatic pressure changes that users apply by controlling their diaphragm or oral muscles into control commands.

All the above sensor outputs are sampled and multiplexed by an ultra low power microcontroller unit (MCU) 116 with a built-in analog-to-digital converter (ADC), which constitutes the core of the headset 106 control unit 108. The MCU 116 also packetizes the digitized samples by organizing them in predefined positions within each data packet and then wirelessly transmits those packets to an external receiver, which is connected to or included in a UMPC or smartphone. The control unit also includes a power management unit 118, which regulates the output voltage of one or more NiMH or Li-Ion batteries 128 to a stable voltage. Power management unit 118 also turns off the sensors and interface circuitry that are not in use to reduce the overall mTDS power consumption and extend the lifetime of its batteries 128.

The control unit 108 can also have a wireless transceiver unit 120 that is connected to or included in an UMPC or a smartphone (such as iPhone, Blackberry, Android, or Windows phones). The transceiver unit 120 has three major functions. First, the transceiver unit 120 acts as a bi-direction data and audio communication gateway between the mTDS headset 106 and a UMPC or smartphone. It wirelessly receives the sensor and audio samples from the mTDS headset and sends them to a UMPC or smartphone for further processing in order to extract users' intention and generate the desired control commands. Second, it also receives the RF back telemetry data from the UMPC or smartphone and sends them wirelessly back to the mTDS headset 106 for the sound playback function and sensor parameter updates. Third, the transceiver unit 120 receives the environmental control commands (issued by the user) from the UMPC or smartphone, converts them into a format that can be recognized by the target devices, and sends them to devices that are in the users' environment through wired or wireless connections.

The wireless link between the headset 106 and the transceiver 120 is a low power and relatively short range one-to-one connection, such as low power RF, low power Bluetooth, or ultra wideband (UWB), which will save the limited stored energy in the mTDS headset batteries 128. More powerful, longer range, and more flexible wireless technologies, such as Zigbee or WiFi, can be used for the wireless connection between the transceiver unit 120 and the target devices in the user's environment.

The control unit 108 can interface with driver software running on the UMPC or smartphone that includes sensor interfacing drivers through I/O ports (such as serial port and USB), a graphical user interface (GUI) and a sensor signal processing (SSP) algorithm, which recognizes the position of the magnetic tracer, hence, the position of the tongue within the oral space, motion and orientation of the head with respect to the gravitational force, and the pneumatic pressure that the user has applied through the plastic straw. After the sensor data packets are received by the transceiver unit 120 and delivered to the UMPC or smartphone via antenna 124, the SSP algorithm extracts the sensor data associated with each input modality and processes them individually to generate a set of control commands that are related to each modality. For example, the SSP algorithm classifies the magnetic sensors' data and converts them into tongue commands. Each of these tongue commands represents a particular tongue movement or position and can be customized based on the users' abilities, oral anatomy, personal preferences, and lifestyle.

The tongue movements associated with user commands can be defined such that they are sufficiently different from the tongue positions and movements during speech and ingestion. In this case, the SSP algorithm would be able to discriminate between signals that represent tongue commands and those that correspond to natural tongue movements resulted from speech, eating, swallowing, coughing, or sneezing. The user can also define a set of particular commands, i.e. tongue movements, which can be discriminated by the local microcontroller (MCU) in the headset that can override the SSP algorithm output to implement some important or emergency functions. These functions include but not limited to toggling the system between standby and active modes, turning additional control modalities on or off, initializing a TDS calibration and re-training procedure in case the system sensitivity to the tongue commands degrades as a result of a shift in the magnetic sensor positions.

The inertial sensor outputs 122 are used to calculate the tilting and the rotation of the head, which can be used to define a set of discrete head control commands or to be directly mapped to the position of a mouse cursor or the speed of the wheelchair for proportional control. The pressure sensor output 110 can also be converted into control commands after being compared with a set of pre-defined thresholds that are customized for each user based on his/her diaphragm strength. The UMPC or smartphone also runs a speech recognition engine to recognize both continuous speech and discrete vocal commands based on the received audio samples from the microphone. The speech recognition engine could be a built-in program, such as Microsoft Windows speech recognition features, or any customized or commercial speech recognition software application, such as Vocal Joystick or Dragon Naturally Speaking.

Commands from different modalities can be used to communicate with and operate their dedicated devices individually so that the user could have simultaneous access to multiple devices at same time, or these commands can be fused together to enrich the control of one device at a time and achieve a higher control accuracy and bandwidth in demanding tasks such as being able to activate numerous controls on a gaming console as well as various shortcuts. It is also possible to combine the information that is available to the SSP algorithm from multiple sensors on the mTDS headset to better manage and compensate for the effects of noise and interference on the accuracy of the user command detection. For instance, when voice commands are corrupted by the ambient noise, it is possible to fuse the information acquired by the magnetic sensors, representing the tongue motion, with the acoustic information from the microphone in the speech processing algorithm to improve the accuracy of the detection of the voice commands.

In some embodiments, an advantage of the present invention is that a single, compact, easy-to-use, easy-to-maintain, wireless, wearable, and relatively low cost system can provide its end users with multiple control solutions, all of which are simultaneously accessible to them, to interact with computers and other devices in their environment for multiple purposes. With this apparatus, the communication between users and their environment are no longer limited by a single channel or modality, which can be easily contaminated or even blocked by noise and interference or users' physical condition or operating environment. A system that expands the physical access beyond one input channel can potentially improve the speed of input command entry by increasing the information transfer bandwidth between users and computers or other machines that are controlled by computers.

In addition, mTDS increases the number of alternatives available to users to accomplish a task, thus gives users the ability to switch among different input modalities, based on their convenience, familiarity, and environmental conditions. For example, in a quiet indoor environment, using head motion for moving the mouse cursor and speech recognition for text entry works well. However, in a noisy environment, the user might prefer to use TDS for both tasks. mTDS can also provide its users with more options to cope with fatigue, which is an important factor that affects the acceptability of ATs, and therefore can result in greater user satisfaction and technology adoption.

Experimental Results

A prototype of one embodiment of the present invention, incorporating one or more features as described in the system of FIG. 1, was constructed. A detailed description of the construction of the various components is provided herein below.

Permanent Magnetic Tracer

Benefiting from the new commercially available high precision and small 3-axial magnetic sensors and a smart custom-designed SSP algorithm, we were able to use a disc-shaped NdFeB rare earth magnet (K&J Magnetics, Jamison, Pa.) with small size (Ø3 mm×1.6 mm) and high residual magnetic strength (Br=14,500 Gauss) as the tracer in this version of the mTDS. Using small magnetic tracers is desired to reduce possible discomfort resulted from the magnet being attached to the tongue. The high Br is desired to compensate for the potential signal-to-noise (SNR) degradation in the magnetic sensor output due to shrinking the size of the magnetic tracer. Being able to use such a small magnetic tracer is also helpful for the users to maintain a clear and unimpaired speech for accurate speech recognition, even though it has been demonstrated that the users can gradually get used to and adjust for any speech impairment resulted from much larger objects in the mouth.

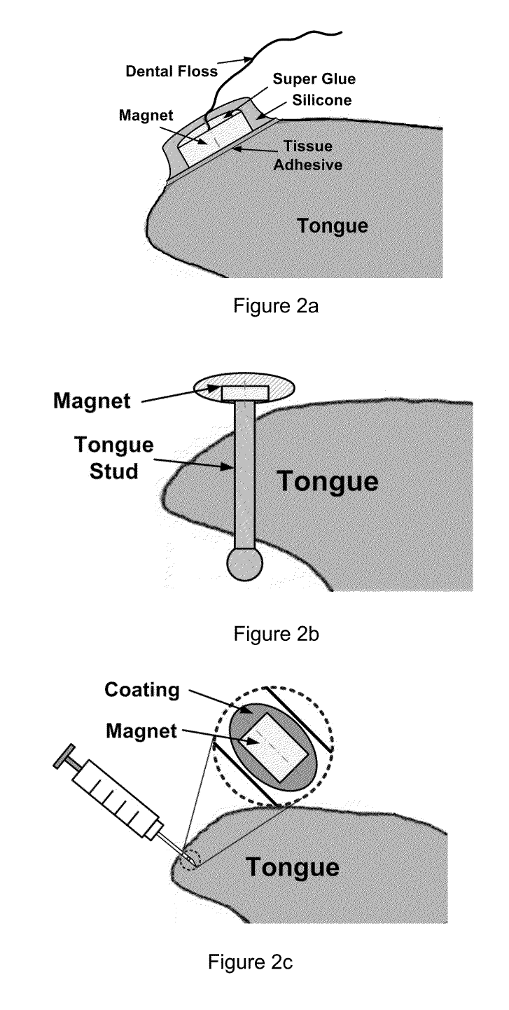

When the magnetic tracer is attached to the users' tongue with tissue adhesive, there is a risk of the magnetic tracer being detached and inadvertently chewed, swallowed, or aspirated. To eliminate this risk, a thin but strong string, such as dental floss, is attached to the magnet using super glue before coating the magnet with medical grade epoxy and silicone, as shown in FIG. 2a. The other end of the string is knotted to the mTDS headset. With the string in place, even if the user swallows or aspirates the magnet, it can be easily extracted.

Another way to attach the magnetic tracer to the users' tongue is through tongue piercing. In this case, small magnetic tracers (Ø3 mm×1.6 mm) are completely encased in a laser welded titanium bead or vacuum set dental acrylic in an otherwise standard straight tongue stud (also known as tongue ring or tongue jewelry). The magnetic bead has been welded to the post. The lower bead is screwed on with a large number of fine threads. FIG. 2b shows an example of such a magnetic tongue stud and the way it appears when it is worn by a user.

There are also smaller magnets (Ø1.6 mm×0.8 mm) commercially available with the same residual magnetic strength. These smaller magnets can be directly injected under the tongue mucosa using a medical syringe and a hypodermic needle after they are coated with inert biocompatible materials, such as Parylene, polyimide, silicone, gold, titanium, platinum, or ceramics, as shown in FIG. 2c.

Wireless Headset

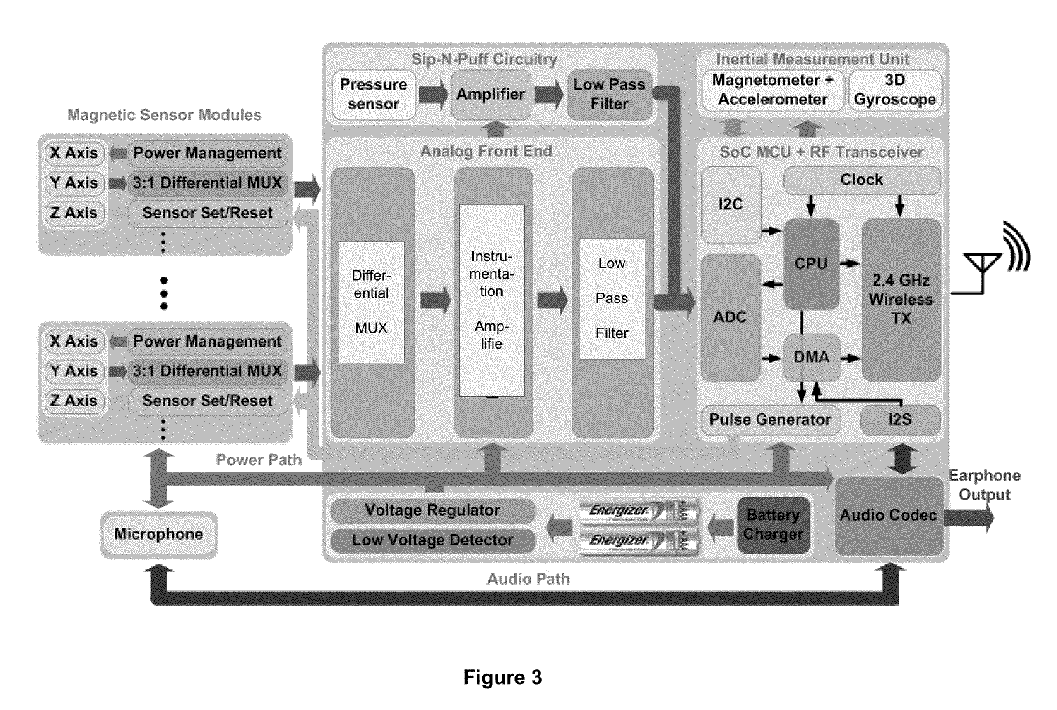

A block diagram of an exemplary wireless headset and control unit, such as headset 106 and control unit 108 of FIG. 1, is shown in FIG. 3. The headset was equipped with a pair of goosenecks, each of which bilaterally holds two 3-axial anisotropic magneto-resistive (AMR) sensors HMC1043 (Honeywell, Morristown, N.J.) near the subjects' cheeks, symmetrical to the sagittal plane. The magnetic sensors, however, can be any other type from a large group of magnetic sensors, some of which were mentioned earlier.

The sensing element of the AMR sensors is made of nickel-iron thin film, which resistance changes in the presence of a magnetic field. This change can be measured using a Wheatstone bridge configuration to characterize both magnitude and direction of the field. In the HMC1043, three orthogonal AMR sensors in X, Y and Z axes measure the 3D magnetic field vector. In the mTDS, the differential output signals from each HMC1043 sensor bridge dedicated to each axis are multiplexed locally on the sensor module. Outputs from the two modules on each side (a total of 4 in this particular implementation) are further multiplexed on the control unit to yield a single time division multiplexed differential input voltage. The time division multiplexed signal is amplified by a low-power, low-noise instrumentation amplifier, INA331 (TI, Dallas, Tex.), with a gain of 200 V/V. A low-power microcontroller (MCU) with built-in analog-to-digital converter (ADC) and 2.4 GHz RF transceiver (CC2510, TI, Dallas, Tex.) samples each sensor output at 50 Hz, while turning on only one sensor at a time to save power. Each sensor is duty cycled at 2%, which results in a total duty cycle of 8% for all 4 sensor modules. To avoid sensor sensitivity and linearity degradation in the presence of strong fields (>20 Gauss) when the magnetic tracer is very close to the sensor (<1 cm), the MCU generates a sharp 2 μs pulse to reset the AMR sensors right before the differential sensor output is sampled. The MCU always compares the left-back side module outputs with a predefined threshold value to check if the user has issued a standby/on command. This threshold is defined as the minimum sensor output when the magnetic tracer is held from the sensor at 1 cm distance. If users hold the tongue close to the left-back module (<1 cm) for more than 3 s, the TDS status switches between operational and standby modes. When the system is in the operational mode, all four sensor outputs are sampled at 50 Hz, and the results are packed into the data frame that is ready for RF transmission. When the standby mode is activated, the MCU only samples the left-back side module axes at 1 Hz and turn off the RF transceiver to save the power.

A 3-axis digital MEMS gyroscope ITG3200 (Invensense, Sunnyvale, Calif.) and a 6-axis digital motion sensor AMI602 (Aichi steel, Tokai, Japan), which incorporates a 3-axis magnetometer and a 3-axis accelerometer, are included in the control unit of the headset to measure the head motion. The ITG3200 outputs are the rotation angles with respect to its X, Y and Z axes, and can be used to calculate the relative rotations of the head. The 3-axis accelerometer of the AMI602 captures the direction of the gravitational force with respect to its own axes while the 3-axis magnetometer measures the direction of the earth magnetic field, which can be mapped onto the absolute direction of the head. With the combination of ITG3200 and AMI602, the 3D direction and orientation of users' heads with respect to the earth magnetic field vector can be derived. The output of the magnetometer can also be used as a reference to cancel out the earth magnetic field components in the AMR sensors which are located along the tip of a pair of goosenecks near the users' cheeks to improve the SNR in tracking the movements of the magnetic tracer. Both ITG3200 and AMI602 generate digitized outputs, and their output can be directly accessed by the MCU through its I2C interface. CC2510 initiates one measurement of both sensors every 20 ms and puts them into deep sleep mode in between two successive samples to reduce the average power consumption of the system. The sampling rate is, therefore, 50 Hz and synchronized with the magnetic sensors measurements for tracking the tongue motion. The measurement results are placed in the same data packets that also include the magnetic sensors' data before transmission.

A compact piezo-resistive pressure sensor, MPX2010 (Freescale, Austin, Tex.), is used to acquire the pneumatic pressure that is applied by the user through the sip-n-puff straw. The sensing mechanism in this pressure sensor is also based on a Wheatstone bridge, similar to the AMR sensors. The differential output of the pressure sensor is amplified by a high precision, low noise, and low power instrumentation amplifier INA333 (TI, Dallas, Tex.) with a gain of 80 V/V and then low-pass filtered at a cut-off frequency of 25 Hz to limit the noise bandwidth. The acquisition of pressure signal is synchronized with the magnetic sensor sampling. The second ADC channel of the CC2510 MCU starts digitizing the amplified and filtered pressure sensor output right after the fourth magnetic sensor output is sampled. Therefore, the pressure sensor is also sampled at 50 Hz. Both the sensor and amplifier are powered off after the each pressure sample is acquired and saved in the MCU memory. The pressure sensor sample is then added to the data frame, similar to the magnetic sensor and inertial samples.

The audio signal acquisition is independent of the other data acquisition modalities, and it is performed by an audio codec TLV320-AIC3204 (TI, Dallas, Tex.), through the built-in inter-IC sound (I2S) interface of the CC2510 MCU. In this particular prototype of the mTDS, a miniaturized SiSonic MEMS microphone (Knowles, Itasca, Ill.) was placed near the tip of the left sensor board to continuously capture the acoustic signal generated from the users' speech. The microphone is directly connected to the audio codec on the control unit which has dedicated power supply, ground, and signal wires to minimize the interference from digital control lines. The audio codec is programmed to operate at the lowest performance level with single-ended mono input, 8 k samples/s sampling rate, and 16 bits of resolution to minimize power consumption. This configuration provided sufficient quality to capture the voice signal in the frequency range of 100˜2000 Hz using the SiSonic microphone with 59 dB SNR.

Digitized audio samples are read by the MCU through I2S and compressed to an 8 bit format using the CC2510 built-in μ-Law compression hardware to save the RF bandwidth. Due to the time critical nature of streaming audio, the audio data transfers within the MCU, i.e. from I2S to RAM and from RAM to the RF transmitter, are accomplished using direct memory access (DMA) architecture to minimize the CPU intervention and the resulting latency. Once a complete audio frame (54 samples) has been acquired in 6.75 ms, the MCU assembles an RF packet containing one audio and one data frame and transmits it wirelessly. Since the audio and data frames are generated at different intervals (6.75 ms vs. 20 ms), only one out of every three RF packets contains both audio and data samples, and the other two include only audio samples. These two types of packets are tagged with different preambles so that they can be recognized and properly disassembled on the receiver side. It should be noted that including an audio frame in the RF data packet is optional, and it is dependent on whether the speech recognition modality has been enabled or not. If the speech recognition is deactivated, the microphone and the ADC block of the audio codec will be powered off, and the RF packets will be slowed down to 50 Hz and only include the data frame. In such a configuration, the power consumption of the headset will be significantly reduced.

After sending out each RF packet, the MCU expects to receive a back telemetry packet including one complete data frame and one optional audio frame, which depends on whether uplink audio channel from the transceiver is active or not. The data frame contains the control commands from the UMPC or smartphone to switch on/off the secondary input modalities. It also includes some of the important operational parameters that can be used to program the mTDS in real time. The audio frame in the back telemetry packet contains digitized sound signals, which can be sourced from short audio tones as auditory feedback, music and songs played on the UMPC or smartphone, or the voice signals that are generated from an incoming phone call on the smartphone, depending on the settings of the mTDS GUI. The MCU extracts the audio samples from the back telemetry packet and sends them to the playback DAC of the audio codec through I2S interface to generate analog audio signals that are audible to the users if they attach an earphone to the designated audio jack on the mTDS headset. In the CC2510 MCU we have used a maximum RF data rate of 500 kbps, which is sufficient for bidirectional data and audio transmission.

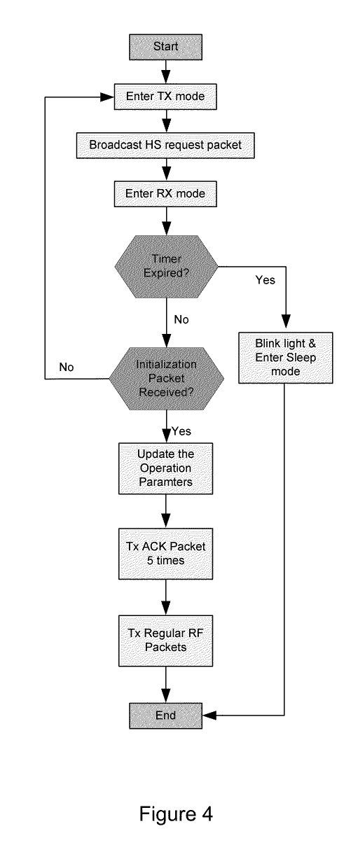

A wireless handshaking mechanism can implemented on both headset and the wireless receiver to establish a dedicated wireless connection between two devices so that their operations are not interfered by other nearby mTDS headsets. FIG. 4 shows the flowchart of the headset MCU firmware, which is related to the wireless handshaking function. When the mTDS headset is just turned on, it enters the initialization mode by default and broadcasts a handshaking request packet containing specific header and its unique network ID using a basic frequency channel (2.45 GHz) at 1 s time intervals for one minute. If the headset receives a handshaking response packet back from a nearby mTDS or TDS transceiver within this one minute initialization time frame, it will update its frequency channel, standby threshold, and other operating parameters which are extracted from the response packet. Then it sends an acknowledgement packet back to the receiver to confirm the handshaking. After that, the mTDS headset switches to the normal operating mode with updated channel frequency and other parameters. Otherwise, the headset will enter the standby mode and blinks a red LED light located on the back of the headset to indicate that the initialization has not been successful, and the power cycle should be repeated.

The power management circuitry includes a pair of AAA Ni—Mn batteries, a voltage regulator, a low voltage detector, and a battery charger. The present mTDS prototype consumes ˜30 mA at 2.5 V supply, and can run for more than 25 hours following a full charge. Table I summarizes some of the key specifications of the current mTDS prototype.

Wireless Transceiver

Two exemplary and non-limiting types of wireless transceivers prototypes have been built for the mTDS to interface with computers, smartphones, and powered wheelchairs (PWC).

USB Transceiver

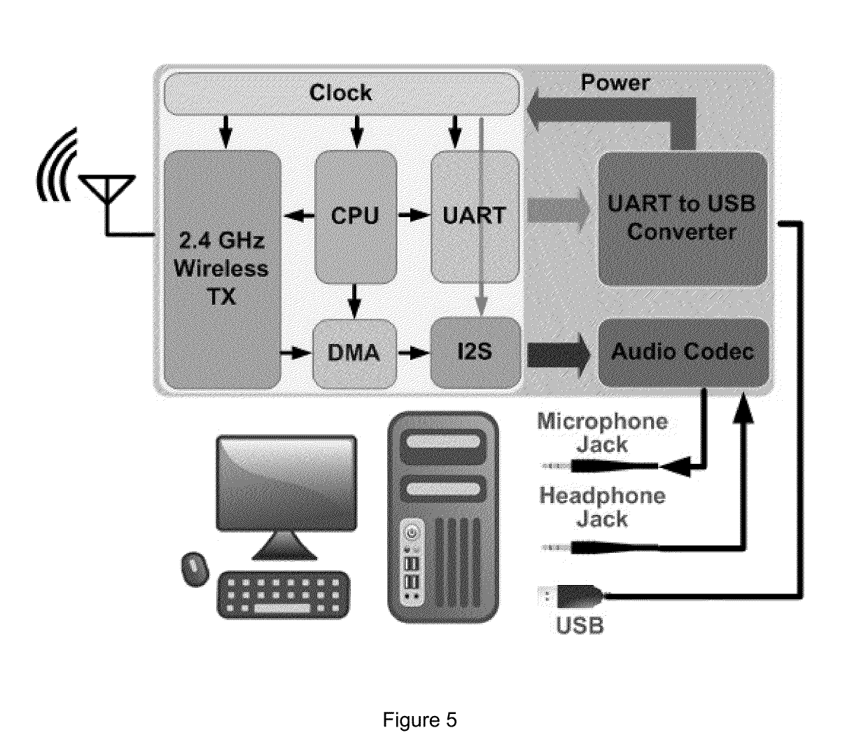

The first type of transceiver is in the form of a USB dongle for computer access. Block diagram of this USB transceiver is shown in FIG. 5. The same type of MCU (CC2510) and audio codec that were used in the mTDS headset are used on this USB transceiver, which has three operating modes: initialization, data transceiver, and file transfer. Switching between different modes is controlled by specific commands sent from the computer.

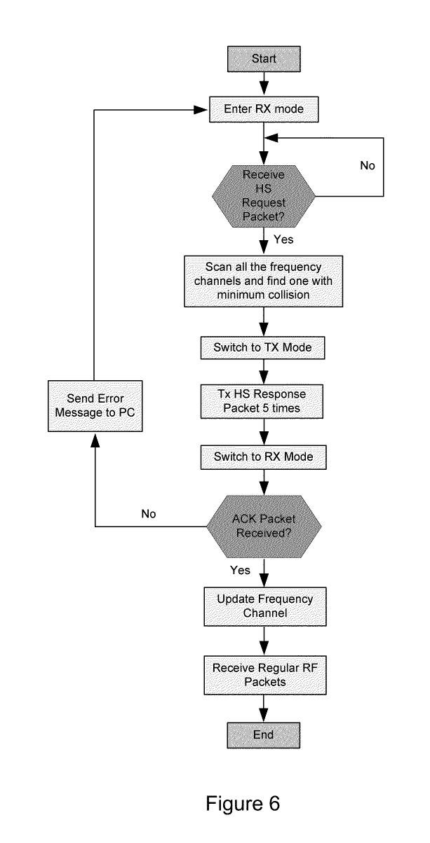

In initialization mode, the transceiver first listens to monitor any incoming handshaking request packets from a nearby mTDS headset. If the transceiver receives a handshaking request packet with an appropriate header and a valid network ID, it will scan through all the available frequency channels, and chooses one with fewer collisions as the optimal communication channel for that specific headset. The transceiver then switches to transmit mode and sends a handshaking response packet to the headset, which includes the assigned frequency channel and several other important operational parameters. The transceiver then switches back to receiver mode and waits for the confirmation via an acknowledgement packet. If an acknowledge packet is received within a specific time frame (5 s), the transceiver will update its frequency channel to the same frequency as the mTDS headset channel and enters data transceiver mode to receive regular sensor and audio packets. Otherwise, the transceiver will notify the computer that the handshaking is failed. FIG. 6 shows the firmware flowchart of this wireless handshaking procedure implemented in the MCU of the transceiver dongle.

When the transceiver is in data transceiver mode, it works like a bi-directional wireless gateway to exchange data and audio samples between the mTDS headset and computer. It receives the RF data packets from the headset, extracts data samples, and delivers them to the computer through USB port. The audio samples, however, are streamed to a playback audio codec through the I2S interface and converted to analog sound signals, which are then applied to the microphone input of the computer through a 3.5 mm audio jack, as shown in FIG. 5. The transceiver can also receive analog audio inputs from the headphone output of the computer through a similar 3.5 mm audio jack and convert them into digital samples using the same audio code and I2S interface that are used to process the playback sound. Alternatively, the transceiver can receive the audio samples in digital format directly through the USB connection from the computer.

These audio samples are compressed using CC2510 built-in μ-law compression hardware, packed into an audio frame and then wirelessly transmitted to the mTDS headset. The transceiver also receives other types of data packets from the computer. One type of data packet contains the mTDS operating parameters and is used to program the mTDS headset in real time. This type of control packet should be combined with the audio frame to form a back telemetry RF packet which is then wirelessly sent back to the headset. Other types of data packets are the control packets, used to communicate with the devices in the users' environment. The content of such packets includes but not limited to the network ID of the target device under control, the RF frequency channel to communicate with that device, and the actual control commands for that device. The transceiver wirelessly sends out these packets using the same RF transceiver that receives packets from the mTDS headset.

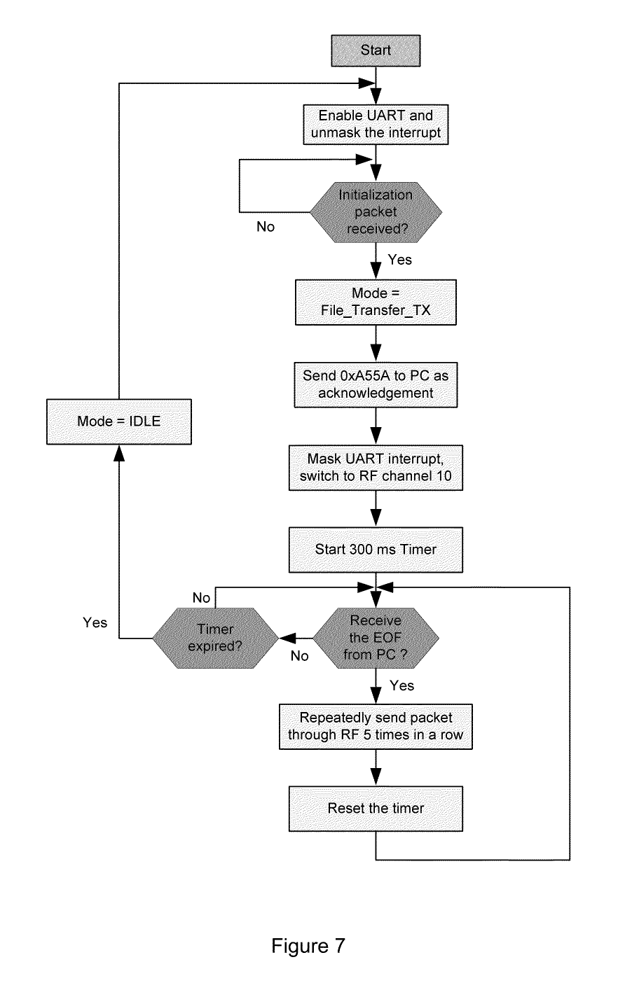

The third mode of the USB transceiver, file transfer mode, is meant to wirelessly transfer user-specific information from the computer to a smartphone, such as iPhone. Similar to computer access, in order to use the smartphone with the mTDS, users need to customize the tongue commands for this specific device based on their preferences, life style, and remaining abilities through a training process, which yields a set of user-specific training data files. Users can perform the training steps either on the computer or directly on the smartphone (iPhone). Perhaps conducting the training steps on the computer is preferable and more convenient due to access to a larger screen. After the training files are generated on the computer, they can be wirelessly transferred to the smartphone and then used for controlling the PWC or other mobile applications that are performed on the smartphone without requiring them to go through yet another training step. In this case, the USB transceiver can be switched to the file transfer mode, in which it operates as a transmitter and wirelessly transmits the user-specific files that it receives from the computer to the smartphone transceiver. FIG. 7 shows the firmware flowchart of the USB transceiver that implements the wireless file transfer function.

PWC-Smartphone Transceiver

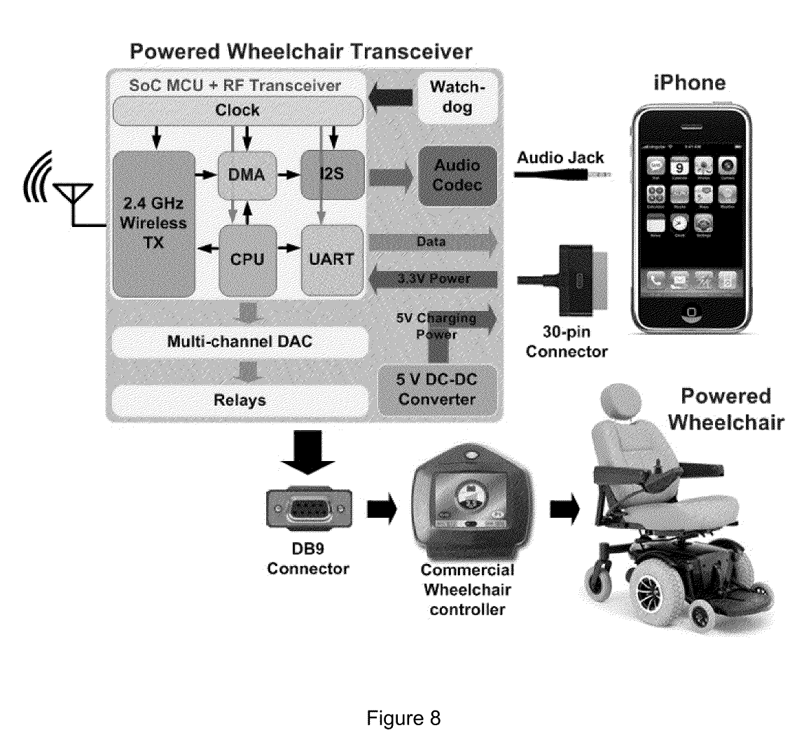

The second type of wireless transceiver is designed for PWC, smartphone, and environmental control in a mobile setup. The transceiver can be attached to a smart device, such as a smart phone (in the prototype, an iPhone was used). The iPhone via its 30-pin charging connector communicates with the mTDS headset using the same mechanism as the PC-based USB transceiver. In addition, the transceiver provides multiple channels of analog output signals to control a PWC through its dedicated 9-pin D-type (DB-9) universal port. FIG. 8 shows the block diagram of the PWC-iPhone transceiver. The circuitry of the PWC-iPhone transceiver includes a low power microcontroller with RF capability (CC2510), a digital-to-analog converter (DAC), an audio codec, a battery charging circuit, a watchdog timer, and two normally open relays. The transceiver is connected to the iPhone through a standard 30 pin interface and uses the RS-232 serial communication protocol to exchange data back and forth with the iPhone. During normal operation, data packets that are wirelessly sent by the mTDS headset are received by the transceiver and sent to iPhone through serial port for further sensor data extraction and processing. The SSP algorithm running on the iPhone interprets the commands issued by the users based on the received sensor data. When the target device is the PWC, these commands are used to modify the speed and rotation vectors that are associated with the PWC's linear speed and rotation rate. State vectors are then sent from iPhone to the PWC-iPhone transceiver to be converted to multichannel analog signals that are compatible with the PWC universal controller using an off-chip digital-to-analog converter, AD5724 (Analog Device, Norwood, Mass.), driven by the CC2510 microcontroller. These analog signals that are in the range of 4.8-7.2 V are applied to the PWC universal control unit through its DB-9 connector to control the wheelchair movements. Considering the PWC supply voltage might be slightly different among the chairs from different vendors (11.5˜12.5 V), one of the CC2510 on-chip ADC channels is utilized to measure the exact value of the PWC supply voltage after it is divided down to below 3V using a resistive divider. The measurement results are used to regulate the reference voltage that is applied to the PWC universal control unit to determine the stationary condition of the chair.

The PWC-iPhone transceiver also includes a playback audio codec to convert the wirelessly received digital audio samples to analog sound signals, which are then applied to the microphone input of the iPhone 3.5 mm audio jack. The input speech signal can be used with iPhone built-in speech recognition engine (Siri) for voice dialing or used with third party applications (such as Avoca VIP Control4) for environmental control. This audio codec can also receive the audio signals from iPhone and convert them into digital samples that can be wirelessly transmitted back to the mTDS headset through the same wireless link. This bi-directional audio link between mTDS headset and iPhone allows the user to directly use the mTDS headset as a hands-free wireless headset to make and receive phone calls without requiring any additional audio input/output device, such as a Bluetooth headset.

To improve safety, a watchdog timer is added to the PWC-iPhone transceiver. If the wireless link is broken due to a malfunction in the mTDS or electromagnetic interference, the slowdown in receiving data packets and control commands is detected by the watchdog timer. In this case, the MCU will reset all control signals to bring the PWC to a standstill. It will not respond to any new incoming data packets until a normal data packet rate is resumed. An additional safety feature is introduced by adding normally open relays between the DAC outputs and the commercial PWC universal control unit. The relays are closed by the microcontroller to route the DAC outputs to the PWC control unit in the normal operating conditions. If the MCU is malfunctioning or the power is lost due to disconnection of the transceiver from the iPhone, the relays will automatically switch to open-circuit and disconnect the DAC outputs from the PWC driver, as if the PWC control unit has not been connected to any external devices. In this case, the built-in safety mechanism of the PWC universal control unit will immediately stop the chair. This can prevent the PWC from being locked in a certain condition when any malfunction or freeze occurs in the MCU or the smartphone.

The PWC-iPhone transceiver receives its power from two sources: First from the 12 V supply pin available in the DB9 PWC universal port, and second from the 3.3 V iPhone power supply available from in the 30 pin connector. The 12 V PWC power supply is mainly used to power the analog part of the DAC and the relays, while the rest of the interface circuits are powered by the 3.3V iPhone supply. In such configuration, even if the PWC is off, the MCU, RF and audio codec circuitry maintain power and continue operating as usual. Therefore, users can still use the mTDS to access all the functions available on the smartphone (iPhone) such as making a phone call, checking contacts, and surfing the internet. A DC-DC converter, LT3653 (Linear Technology, Milpitas, Calif.), converts the 12 V PWC voltage down to 5 V, which has been used to charge the iPhone through its 30 pin connector from the large PWC batteries.

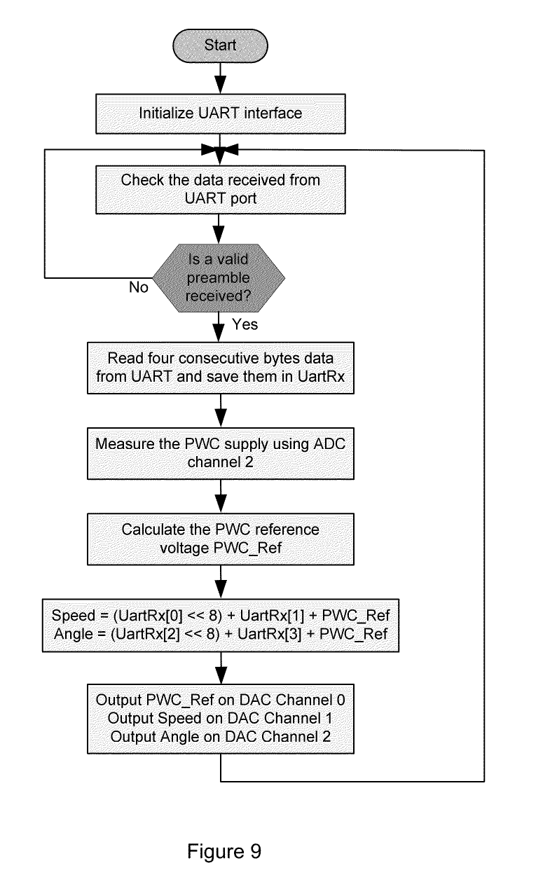

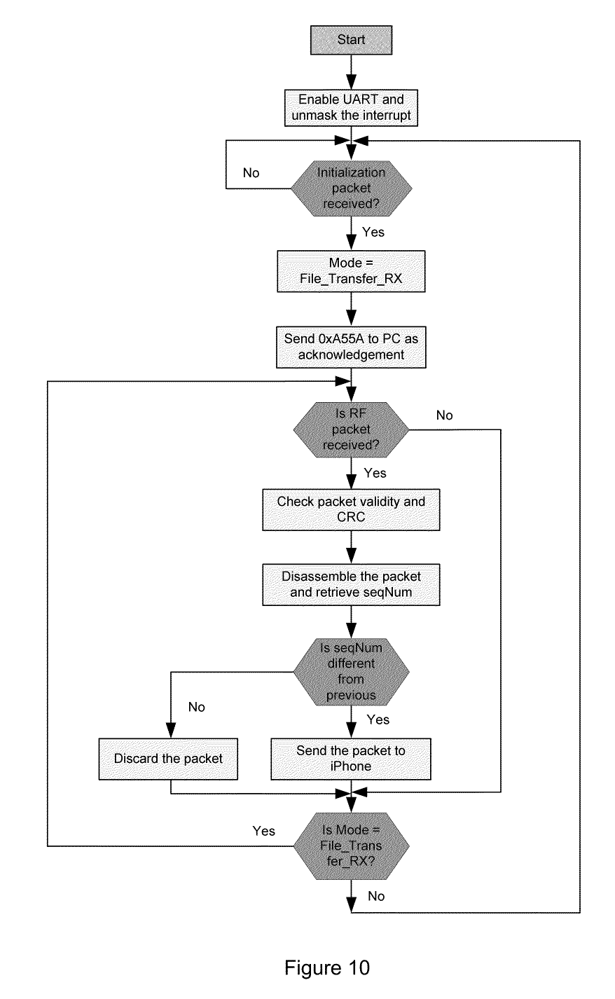

Similar to the PC USB transceiver, the PWC-iPhone transceiver has three operating modes. The first mode, which is the initialization mode, is exactly the same as the USB transceiver and it is used to establish a one-to-one connection between the mTDS headset and the PWC-iPhone transceiver. In the data transceiver mode, the difference between the USB transceiver and the PWC-iPhone transceiver is that the latter has been equipped with an additional DAC to convert digital commands that are detected by the SSP algorithm and used to modify the PWC linear and rotation vectors into analog voltage levels to control the PWC motion. FIG. 9 shows the flowchart of PWC control function implemented on the PWC-iPhone transceiver. In the file transfer mode, the PWC-iPhone transceiver is configured as a receiver to receive the user-specific trainings files and send them to the iPhone, which in turn saves the files and uses them to detect control commands during mTDS operation. FIG. 10 shows the flowchart of PWC-iPhone transceiver operation in the file transfer mode.

Alternatively, the USB wireless transceiver and the PWC-iPhone transceiver can be combined into one piece, which is capable of both computer access and PWC control. In this case, a Bluetooth low energy module with HID (Human Interface Device) profile will be incorporated with the PWC-iPhone transceiver and used to emulate a Bluetooth mouse function. However, unlike a traditional Bluetooth mouse which receives the movement information from an optical sensor, the Bluetooth module in the mTDS transceiver will directly receive this information from the iPhone after it processes the magnetic sensor signal. Then the Bluetooth module will assemble and transmit this information in the same way as a regular Bluetooth mouse does so that the mTDS transceiver will be recognized as a Bluetooth mouse by any commercial Bluetooth receiver. In this way, the user can use mTDS to control the mouse cursor on any computer or smartphone with Bluetooth capability, either built-in or with a small add-on dongle, without running additional software in the background.

Graphical User Interface (GUI)

Even though the mTDS GUI runs in the LabVIEW environment, its SSP engine has been implemented in C to improve the computational efficiency and speed. For detecting the tongue commands, the SSP algorithm uses the K-Nearest-Neighbors (KNN) classifier to identify the incoming magnetic sensor samples based on their features, which are extracted through Principal Components Analysis (PCA) from the data that is collected during a training step and prior to the main operation, The current mTDS prototype supports six individual tongue commands that are simultaneously available to the user including four directional and two selection commands. The directional commands can be used to navigate the cursor towards UP, DOWN, LEFT, and RIGHT in a computer access task, or drive the wheelchair FORWARD and BACKWARD, and turn it LEFT and RIGHT. The selection commands can be used to emulate mouse clicks in computer access, or to switch the PWC between driving and seating control mode for the users' weight management procedure.

A simple but efficient threshold based algorithm was implemented to detect pneumatic diaphragm control commands (sip-n-puff) based on the received pressure sensor signals. In the current algorithm, four different thresholds that are customized according to users' ability and preference are used to discriminate between different pressure levels that indicate four directional commands: hard puff (FORWARD), hard sip (BACKWARD), soft sip (LEFT), and soft puff (RIGHT). These commands are defined similar to the conventional sip-n-puff devices, such that the users who have prior experience with sip-n-puff can transition to mTDS without any problem. These commands can also be used as a set of standalone commands to control mouse cursor or to drive a PWC. They can also be used as a complementary command set besides the TDS commands to expand the number of commands that are simultaneously available to the mTDS users.

A customized head position and orientation tracking algorithm has been developed and implemented in both PC and iPhone platforms. The accelerometers outputs contain both static and dynamic components, measuring accelerations induced by the gravitational force and voluntary head motions. In this prototype, we are using the static components which represent the tilting of the users' heads relative to the ground when users are relatively stationary, such as sitting in front of a computer. To calculate the relative head orientation, we defined three parameters: pitch (ρ), roll (φ), and theta (θ). Pitch (ρ) is defined as the angle of X-axis relative to ground. Roll (φ) is defined as the angle of the Y-axis relative to ground, and theta (θ) is the angle of the Z-axis relative to gravity. These angles can be calculated using the following equations:

$$ρ = arc tan ( \frac{{A}_{x}}{\sqrt{{A}_{y}^{2} + {A}_{z}^{2}}} )$$

$$ϕ = arc tan ( \frac{{A}_{y}}{\sqrt{{A}_{x}^{2} + {A}_{z}^{2}}} )$$

$$θ = arc tan ( \frac{\sqrt{{A}_{x}^{2} + {A}_{y}^{2}}}{{A}_{z}} )$$

where Aₓ, A_{y}, and A_{z} are the accelerometers' outputs in each axis. This calculation, however, is valid only when users are relatively stationary. If users are moving on their wheelchairs, dynamic acceleration components measured by the inertial sensors can be comparable to those statistical components. Hence, using a 3-axis accelerometer alone to measure the tilting of the head is not accurate. In the case of the mTDS, the information acquired by the magnetometer and the gyroscope can be used to compensate for the above deficiency. After being properly calibrated, the three components (X, Y and Z) of the magnetometer can be used to measure the local earth magnetic field, which strength and direction with respect to the North Pole is known if the geographical position and latitude is determined. This information is used to calculate the absolute orientation of the users' heads within the earth coordinates, including the tilting of the head relative to the ground. Meanwhile, the output of the 3-axis gyroscope is fed into the algorithm to extract the relative head rotation in all 3-axes in a much more accurate way. Combining magnetometer and gyroscope outputs can provide accurate head rotation information, in a way that it is insensitive to the linear movements of the head and can be used for PWC control or other applications when users are driving their wheelchairs.

In some embodiments, any piece of commercially available or customized speech recognition software that works with a regular microphone can be used with the mTDS, because the audio signals are directly applied to the microphone input of the computer or smartphone. Dragon Naturally Speaking (Nuance, Burlington, Mass.) was the choices in this prototype since it has been widely used by the disability community and supports a wide variety of platforms (Windows, Mac, iPhone, etc.). Microsoft Windows speech recognition (Microsoft, Redmond, Wash.) program, which is included in the Windows operating system is also a good option for Windows users, who may not want to incur the extra cost of the speech recognition software. Other speech recognition software that work with the mTDS includes but is not limited to: Talking Desktop, Sonic Extractor, SpeechMagic, Tazti, e-Speaking, and Avoca VIP Control Edition.

A web browsing experiment was designed to evaluate the performance of the mTDS in completing realistic computer access tasks that involved both mouse navigation and typing. During the experiment, the subject (a 30 year old male) was asked to wear the mTDS headset and sit ˜1 m away from a 22″ monitor with 1280×800 resolution. The subject trained the Dragon Naturally Speaking software by reading 10 short passages provided by the manufacturer. Then he conducted the TDS calibration, tracer attachment, command identification, and training steps to define his six mTDS tongue commands.

The mouse cursor was initially positioned in the middle of the monitor screen and the subject was required to navigate the cursor to complete the following tasks in the same order, while the computer kept track of the elapsed time and user commands: 1) Open a web browser [Internet Explorer] by clicking on its icon in the Windows-XP start menu; 2) Type www.amazon.com in the browser address bar and click on the [Go] button to reach the Amazon website; 3) Type wireless mouse in the search box and click on [Search] button to find the related products; 4) Click on the name of the first item in the list of search results and then click on [Add to Cart] button to add the item to the shopping cart; 5) Click on [Proceed to checkout] button; 6) Close the browser by clicking on the red cross on the top right side of the browser window. All in all, the subject had to complete a minimum of 15 mouse cursor movements (excluding those for typing with mTDS), 9 mouse clicks, and 28 typed-in characters. The subject's activities on the computer screen was recorded using Camtasia Studio (TechSmith, Okemos, Mich.) and analyzed offline to derive the performance merits, such as typing time, cursor navigation time and total completion time.

The subject was required to complete the task using the mTDS alone without Dragon (using tongue commands only similar to TDS), Dragon Naturally Speaking alone, and the mTDS with Dragon. The task was repeated four times for each variation, one for practice followed by three testing trials. When using the TDS, the microphone was turned off to deactivate Dragon. In this case, the directional TDS commands were used to move the cursor on the screen in four directions and the selection commands were used to issue mouse left-click and double-click. Typing in this case was accomplished by navigating the cursor and clicking on an on-screen keyboard (Click-N-Type, Lake Software). When using Dragon, the TDS function was disabled by shutting down the LabVIEW GUI. A set of predefined verbal commands, such as move mouse Left/Right/Up/Down, move mouse slow, much faster, and mouse left/right click, were used to move the cursor and issue mouse clicks through the dictation. In the multimodal mode, both the mTDS and Dragon were active, and the subject was required to use the tongue commands (TDS) for mouse navigation and clicks, and verbal commands (Dragon) for typing.

Besides the benefit of being a multimodal device, each input modality of various embodiments of the present invention can have its own benefits, and the present invention can take advantage of the best of multiple worlds:

1) Tongue motion: An advantage of the tongue operated TDS over conventional systems is that a few magnetic sensors and an inherently wireless small permanent magnet can capture a large number of tongue movements, each of which can represent a specific command. A set of dedicated tongue movements can be tailored for each individual user based on his/her preferences, lifestyle, and remaining abilities, and mapped onto a set of customized functions for environmental access. Therefore, TDS can benefit a wide range of potential users with different types of disabilities because of its adaptive operating mechanism. By tracking tongue movements in real time, TDS also has the potential to provide its users with proportional control, which is easier, smoother, and more natural than the switch-based control for complex tasks such driving a PWC in confined spaces. Unlike many alternative technologies, TDS can operate satisfactorily even in the presence of noise, interference or involuntary body movements. By properly implementing the noise cancellation strategy, the system has high resistance to interference from external magnetic field as well as the unintentional tongue movements due to the speaking, coughing or other natural activities.

2) Speech recognition: This modality has almost unlimited number of available commands, and it is regarded as one of the most efficient ways for text entry, which after training in a quiet environment can even outperform rapid typing with a keyboard. Individuals with severe disabilities can benefit from this technology as long as their vocal abilities are intact. The speech recognition technology has been well developed over the last two decades and high performance software is available at low cost in the commercial market. The speech recognition software also allows its user to navigate the mouse cursor using a set of predefined voice commands. However, in this respect it is not as efficient as other modalities. A wide variety of speech recognition software that is commercially available can be directly used with mTDS with no modifications.

3) Head motion tracking: Using inertial sensors for tracking head motion eliminates the need for mTDS users to be sitting in front of a camera, which is the method used in many optical-based head tracking devices, for this modality to work. Therefore, this kind of head tracking system provides the user with greater flexibilities and can be used for wheelchair control on smooth surfaces as well. The outputs of the inertial sensors are proportional to the relative position and orientation of the head with respect to the gravitational force and the earth magnetic field. This information can be used to implement proportional control, such as moving a mouse cursor in a 2D computer screen or manipulating a robotic arm or prosthetic limb in a 3D space. Lack of selection function, such as mouse clicks, in head tracking devices can be compensated by using tongue or vocal commands along with head tracking.

4) Diaphragm control: Sip-n-puff is one of the most widely used assistive devices for wheelchair control. Many patients have already become quite familiar with sip-n-puff devices and use them on a daily basis. Having sip-n-puff as an input modality in mTDS allows such patients to have a smooth transition to mTDS and always have access to the device that they are familiar with at the beginning and as a backup later on, while they learn how to use the new more powerful input modalities such as TDS or head tracking. This will enhance users' confidence and help them migrate from an old technology to new ones with minimum difficulty. Once users learned how to effectively use the other mTDS modes of operation, they can keep the diaphragm control feature disabled and even remove the straw from the headset, unless when they are engaged in a high demand task that needs this additional input modality.

By combining two or more of the above input modalities in one highly compact, wearable, and wireless device, the mTDs can provide its end users with a unique experience, in which they can not only enjoy the benefits of each modality by itself, as mentioned above, but also have access to a combination of a subset of all of these modalities at the same time without any assistance from a caregiver while switching from one modality to another. The complementary features in mTDS are expected to provide users with higher bandwidth, accuracy, flexibility, and robustness against ambient noise, interference, and motion artifacts, which can otherwise render a traditional AT useless. The integrated mTDS solution in a wireless and wearable form also facilitates mobility, installation and setup, adjustment, and maintenance of a single system for all of the users' daily activities as opposed to multiple devices, each designed for a specific task or a specific environment. This not only helps users but also lowers the costs and makes the caregivers' and family members' lives easier.

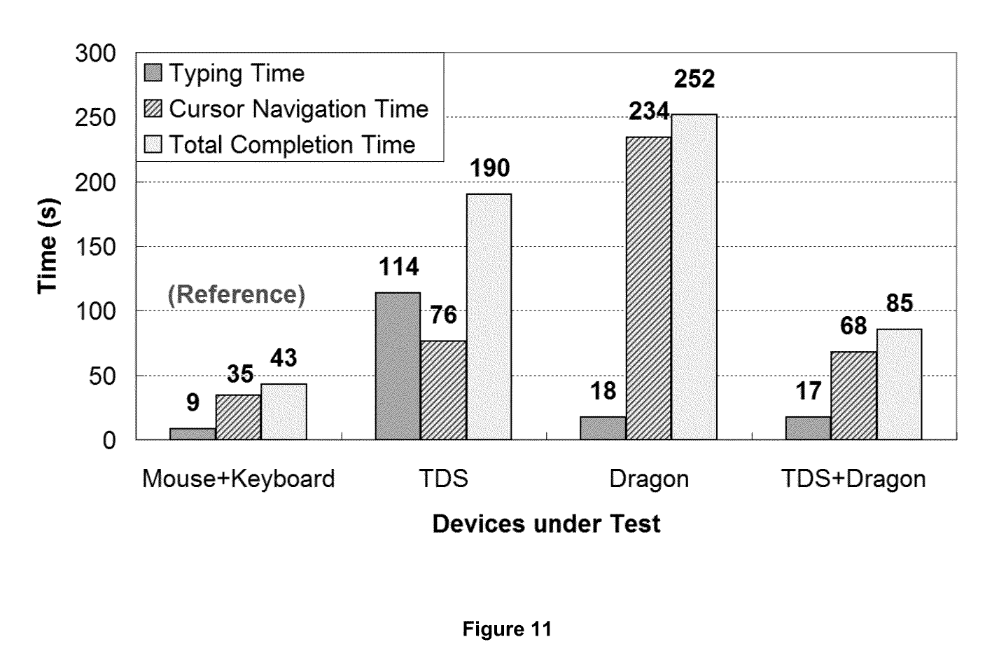

FIG. 11 depicts the results from human subject trials, divided into the typing time, cursor navigation time, and total time for completing the task using three different solutions. We also asked the subject to perform the same task with standard mouse and keyboard to have a reference point. Overall, using the mTDS resulted in the best performance in all aspects of the task. TDS outperformed Dragon in term of cursor navigation time (76 s vs. 234 s), while the Dragon was much faster in typing than TDS (18 s vs. 114 s). The subject obviously benefited from using both devices, evident from his minimum total completion time when using the mTDS, which was about 42% and 34% of that of using TDS alone and Dragon alone, respectively. Interestingly, the cursor navigation time of TDS did not vary much whether it was used alone or with Dragon. Similarly, the typing time with Dragon was basically the same with and without TDS. These results show that TDS and Dragon are complementary, meaning that they can be used together and independently without degrading the users' performance with each individual input device.

While the present disclosure has been described in connection with a plurality of exemplary aspects, as illustrated in the various figures and discussions above, it is understood that other similar aspects can be used or modifications and additions can be made to the described aspects for performing the same function of the present disclosure without deviating therefrom. Therefore, the present disclosure should not be limited to any single aspect, but rather construed in breadth and scope in accordance with the appended claims.

What is claimed is:

1. A multi-modal communication system for use by a subject, the system comprising:
a primary modality comprising:
a tongue tracking unit comprising:
a tracer unit for use on a tongue of the subject;
a sensing unit comprising a primary sensor configured for placement in proximity to tongue carrying the tracer unit, wherein the primary sensor detects a position of the tracer unit to output a first type of communication; and
a plurality of secondary modalities comprising one or more secondary sensors to output a second type of communication.

2. The system of claim 1, wherein the first type of communication is proportional and the one or second types of communications are discrete.

3. The system of claim 1, wherein the first type of communication is discrete and the second type of communication is proportional.

4. The system of claim 1, wherein the tracer unit comprises a magnet.

5. The system of claim 4, wherein the magnet is coated with a material selected from the group consisting of gold, platinum, titanium, and polymeric material.

6. The system of claim 4, wherein the magnet is affixed to the tongue by piercing the tongue with a piercing embedded with the magnet or is glued to the tongue.

7. The system of claim 1, wherein sensing unit is selected from the group consisting of a headset and a mouthpiece.

8. The system of claim 1, wherein the one or more secondary sensors comprises a head motion sensor.

9. The system of claim 8, wherein the head motion sensor comprises an inertial measurement unit.

10. The system of claim 9, wherein the inertial measurement unit comprises at least one of a 3-axial magnetometer, a 3-axial accelerometer or a 3-axial gyroscope.

11. The system of claim 1, wherein the one or more secondary sensors comprises a speech or acoustic sensor.

12. The system of claim 11, wherein the speech or acoustic sensor comprises a microphone.

13. The system of claim 12, wherein the speech or acoustic sensor further comprises an earphone.

14. The system of claim 1, wherein the one or more secondary sensors comprises a respiratory or pneumatic pressure sensor.

15. The system of claim 14, wherein the respiratory or pneumatic pressure sensor comprises a tube configured to transmit breathing or diaphragm pressure generated by the subject.

16. The system of claim 1, wherein the sensing unit further comprises a wireless transceiver unit for wirelessly transmitting and receiving data.

17. A communication method, the method comprising:
positioning a primary input modality comprising a tongue tracking unit on a tongue of a subject, the tongue tracking unit comprising:
a tracer unit for use on a tongue of the subject;
a sensing unit comprising a primary sensor configured for placement in proximity to tongue carrying the tracer unit, wherein the primary sensor continuously detects a position of the tracer unit to output a first type of communication; and
providing a plurality of secondary modalities comprising one or more secondary sensors to output a second type of communication.

18. The method of claim 17, wherein the first type of communication is proportional and the second type of communication is discrete, proportional or a combination thereof.

19. The method of claim 17, wherein the first type of communication is discrete and the second type of communication is proportional, discrete or a combination thereof.

20. The method of claim 17, wherein the tracer unit comprises a magnet.

21. The method of claim 17, wherein the magnet coated with a material selected from the group consisting of gold, platinum, titanium, and polymeric materials.

22. The method of claim 21 further comprising affixing the magnet to the tongue by piercing the tongue with a piercing embedded with the magnet, gluing the magnet to the tongue, or implanting the magnet in the tongue.

23. The method of claim 17, wherein sensing unit is selected from the group consisting of a headset and a mouthpiece.

24. The method of claim 17, further comprising a third sensor to output a third type of communication.

25. The method of claim 24, wherein the third sensor is a head motion sensor.

26. The method of claim 25, wherein the head motion sensor comprises an inertial measurement unit.

27. The method of claim 26, wherein the inertial measurement unit comprises a 3-axial magnetometer, a 3-axial accelerometer and a 3-axial gyroscope.

28. The method of claim 24, wherein the third sensor is an acoustic sensor.

29. The method of claim 28, wherein the acoustic sensor comprises a microphone.

30. The method of claim 29, further comprising an earphone.

31. The method of claim 24, further comprising a fourth sensor comprising a pneumatic pressure sensor to output a fourth type of communication.

32. The method of claim 31, wherein the pneumatic pressure sensor comprises a tube configured to transmit diaphragm pressure generated by the subject.

33. The method of claim 17, wherein the sensing unit further comprises a wireless transceiver unit for wirelessly transmitting and receiving data.

34. The method of claim 31 further comprising combining the first type of communication with one or more of the second type of communication, third type of communication and fourth type of communication to output a fifth type of communication.

35. The method of claim 17, further comprising sending the first type of communication as an input to a plurality of secondary modalities.
